(19) United States
(12) Patent Application Publication
(10) Pub. No.: US 2023/0097108 A1
(43) Pub. Date: Mar. 30, 2023

(54) ANODE COATING PROCESS

(71) Applicant: Altech Chemicals Australia Pty Ltd., Subiaco, Western Australia (AU)

(72) Inventor: JINGYUAN LIU, Subiaco, Western Australia (AU)

(21) Appl. No.: 17/781,277

(22) PCT Filed: May 13, 2022
(86) PCT No.: PCT/AU2022/050461

§ 371 Date: May 31, 2022

(30) Foreign Application Priority Data
May 13, 2021 (AU) 2021901429

(51) Int. Cl. H01M 4/04; H01M 4/583; H01M 4/38; H01M 4/485

(52) U.S. Cl. CPC H01M 4/0471; H01M 4/583; H01M 4/386; H01M 4/485; H01M 2004/027

(57) ABSTRACT

A method for preparing an anode active material is provided. The method includes the steps of combining an anode material with a solution of aluminium chloride hexahydrate to form a coated anode material, and calcining the solid particles to form a calcined material comprising solid particles with an alumina-containing coating. The alumina-containing coating may completely cover the surface of each particle or only partially cover the surface of each particle. Alternatively, some particles may be completely covered with the alumina-containing coating and some particles only partially covered with the alumina-containing coating. The alumina-containing coating serves as an artificial solid electrolyte interphase (SEI), reducing the lithium loss at first cycle and inhibiting the degradation of SEI during cycling thereby improving the first coulombic efficiency and cyclability.

### CROSS REFERENCE TO RELATED APPLICATIONS

This application is the National Stage of International Application No. PCT/AU2022/050461, filed on May 13, 2022, which claims the priority of Australian Patent Application No. 2021901429, filed on May 13, 2021, which are incorporated herein by reference in its entirety.

### TECHNICAL FIELD

The present invention relates to methods for coating anode active materials.

### BACKGROUND OF THE INVENTION

The following discussion of the background to the invention is intended to facilitate an understanding of the present invention. However, it should be appreciated that the discussion is not an acknowledgement or admission that any of the material referred to was part of the common general knowledge in Australia or any other country as at the priority date.

Anodes are one of the major components for lithium ion batteries. Most commercial lithium-ion cells use graphitic-carbon as the anode material. Silicon has attracted great attention because of its natural abundance, lack of toxicity and high theoretical specific capacity (nearly 4200 mAhg⁻¹). Silicon alloy is a potential new generation anode material in the near future.

However, many anode materials suffer from volume changes of lithium insertion/de-insertion cycling and such changes result in pulverization of the anode and the formation of an unstable solid electrolyte interphase (SEI) layer. This causes capacity decay and limits the use of the anodes in commercial applications. Eventually, the cracks due to strain leads to loss of anode particle connectivity and electrode delamination, which affect both battery capacity and cycle life.

Many anodes also suffer from low first coulombic efficiency and capacity degradation rate during charge-discharge cycle. First coulombic efficiency reduction is due to the irreversible lithium consumption by the formation solid electrolyte interface (SEI) during the first charge-discharge cycle.

Thus, there remains a need for improved approaches for the preparation of anodes.

### SUMMARY OF INVENTION

In accordance with the present invention, there is provided a method for preparing an anode active material, the method comprising the steps of:

combining an anode material with a solution of aluminium chloride hexahydrate to form a coated anode material;

calcining the coated anode material to form a calcined material comprising solid particles with an alumina-containing coating.

It will be appreciated that the alumina-containing coating may completely cover the surface of each particle or only partially cover the surface of each particle. Alternatively, some particles may be completely covered with the alumina-containing coating and some particles only partially covered with the alumina-containing coating.

Advantageously, the alumina-containing coating serves as an artificial SEI, reducing the lithium loss at first cycle and inhibiting the degradation of SEI during cycling thereby improving the first coulombic efficiency and cyclability.

In one form of the invention, the step of combining an anode material with a solution of aluminium chloride hexahydrate to form a coated anode material comprises mixing the anode material with the solution of solution of aluminium chloride hexahydrate.

Where the step of combining an anode material with a solution of aluminium chloride hexahydrate to form a coated anode material comprises mixing the anode material with the solution of solution of aluminium chloride hexahydrate, the method may comprise the additional step of solid/liquid separation to provide a liquid and the coated anode material.

In an alternate form of the invention, the step of combining an anode material with a solution of aluminium chloride hexahydrate to form a coated anode material comprises adding the solution of aluminium chloride hexahydrate to the anode material for example, by spraying or injecting the solution onto the anode material, followed by mixing.

The anode material may be provided in the form of graphite powder, silicon powder, nano-silicon particles, silicon-carbon composite powder, carbon nanotubes Li₄Ti₅O₁₂ (spinel), TiO₂, SnO₂, Ge, Si, SOx (0<x<2), Sn, Sb, Bi and Zn. Preferred anode materials are graphite powder and silicon powder.

Preferably, the anode material is a powder.

It will be appreciated that the preferred mean particle size of the anode material will be influenced by the anode material itself. Without being limited by theory, it is believed that smaller particles of silicon are preferred with anode materials as silicon that at are more prone to expansion and contraction. By contrast, larger particles can be used for anode materials such as graphite, that are less prone to expansion and contraction.

The particle size distribution of the anode materials were measured using laser diffraction on a Malvern Mastersizer MS2000.

In one form of the invention, the anode material has a mean particle size between 10 nm and 3000 nm. In an alternate form of the invention, the anode material has a mean particle size between 50 nm and 2000 nm. In an alternate form of the invention, the anode material has a mean particle size between 100 nm and 1500 nm. In an alternate form of the invention, the anode material has a mean particle size between 100 nm and 1000 nm. In an alternate form of the invention, the anode material has a mean particle size between 300 nm and 500 nm.

In one form of the invention, the anode material has a mean particle size of about 100 nm. In an alternate form of the invention, the anode material has a mean particle size of about 150 nm. In an alternate form of the invention, the anode material has a mean particle size of about 200 nm. In an alternate form of the invention, the anode material has a mean particle size of about 250 nm. In an alternate form of the invention, the anode material has a mean particle size of about 300 nm. In an alternate form of the invention, the anode material has a mean particle size of about 350 nm. In an alternate form of the invention, the anode material has a mean particle size of about 400 nm. In an alternate form of the invention, the anode material has a mean particle size of about 450 nm. In an alternate form of the invention, the anode material has a mean particle size of about 500 nm. In an alternate form of the invention, the anode material has a mean particle size of about 550 nm. In an alternate form of the invention, the anode material has a mean particle size of about 600 nm. In an alternate form of the invention, the anode material has a mean particle size of about 650 nm. In an alternate form of the invention, the anode material has a mean particle size of about 700 nm. In an alternate form of the invention, the anode material has a mean particle size of about 750 nm. In an alternate form of the invention, the anode material has a mean particle size of about 800 nm. In an alternate form of the invention, the anode material has a mean particle size of about 850 nm. In an alternate form of the invention, the anode material has a mean particle size of about 900 nm. In an alternate form of the invention, the anode material has a mean particle size of about 950 nm. In an alternate form of the invention, the anode material has a mean particle size of about 1000 nm.

In one form of the invention, the anode material has a mean particle size less than 100 nm. In an alternate form of the invention, the anode material has a mean particle size less than 150 nm. In an alternate form of the invention, the anode material has a mean particle size less than 200 nm. In an alternate form of the invention, the anode material has a mean particle size less than 250 nm. In an alternate form of the invention, the anode material has a mean particle size less than 300 nm. In an alternate form of the invention, the anode material has a mean particle size less than 350 nm. In an alternate form of the invention, the anode material has a mean particle size less than 400 nm. In an alternate form of the invention, the anode material has a mean particle size less than 450 nm. In an alternate form of the invention, the anode material has a mean particle size less than 500 nm. In an alternate form of the invention, the anode material has a mean particle size less than 550 nm. In an alternate form of the invention, the anode material has a mean particle size less than 600 nm. In an alternate form of the invention, the anode material has a mean particle size less than 650 nm. In an alternate form of the invention, the anode material has a mean particle size less than 700 nm. In an alternate form of the invention, the anode material has a mean particle size less than 750 nm. In an alternate form of the invention, the anode material has a mean particle size less than 800 nm. In an alternate form of the invention, the anode material has a mean particle size less than 850 nm. In an alternate form of the invention, the anode material has a mean particle size less than 900 nm. In an alternate form of the invention, the anode material has a mean particle size less than 950 nm. In an alternate form of the invention, the anode material has a mean particle size less than 1000 nm.

In one form of the invention, the anode material has a mean particle size more than 100 nm. In an alternate form of the invention, the anode material has a mean particle size more than 150 nm. In an alternate form of the invention, the anode material has a mean particle size more than 200 nm. In an alternate form of the invention, the anode material has a mean particle size more than 250 nm. In an alternate form of the invention, the anode material has a mean particle size more than 300 nm. In an alternate form of the invention, the anode material has a mean particle size more than 350 nm. In an alternate form of the invention, the anode material has a mean particle size more than 400 nm. In an alternate form of the invention, the anode material has a mean particle size more than 450 nm. In an alternate form of the invention, the anode material has a mean particle size more than 500 nm. In an alternate form of the invention, the anode material has a mean particle size more than 550 nm. In an alternate form of the invention, the anode material has a mean particle size more than 600 nm. In an alternate form of the invention, the anode material has a mean particle size more than 650 nm. In an alternate form of the invention, the anode material has a mean particle size more than 700 nm. In an alternate form of the invention, the anode material has a mean particle size more than 750 nm. In an alternate form of the invention, the anode material has a mean particle size more than 800 nm. In an alternate form of the invention, the anode material has a mean particle size more than 850 nm. In an alternate form of the invention, the anode material has a mean particle size more than 900 nm. In an alternate form of the invention, the anode material has a mean particle size more than 950 nm. In an alternate form of the invention, the anode material has a mean particle size more than 1000 nm.

In one form of the invention, the anode material has a mean particle size between 2 and 100 microns. In an alternate form of the invention, the anode material has a mean particle size between 10 microns and 50 microns. In an alternate form of the invention, the anode material has a mean particle size between 20 microns and 30 microns.

The solution of aluminium chloride hexahydrate may be provided at a concentration of 0.1 M to 3.44 M (saturation at 20° C.). Preferably, the solution of aluminium chloride hexahydrate is provided at a concentration of 0.5 M to 2 M.

In one form of the invention, the solution of aluminium chloride hexahydrate is provided at a concentration of about 0.25 M. In an alternate form of the invention, the solution of aluminium chloride hexahydrate is provided at a concentration of about 0.50 M. In an alternate form of the invention, the solution of aluminium chloride hexahydrate is provided at a concentration of about 0.75 M. In an alternate form of the invention, the solution of aluminium chloride hexahydrate is provided at a concentration of about 1.00 M. In an alternate form of the invention, the solution of aluminium chloride hexahydrate is provided at a concentration of about 1.25 M. In an alternate form of the invention, the solution of aluminium chloride hexahydrate is provided at a concentration of about 1.50 M. In an alternate form of the invention, the solution of aluminium chloride hexahydrate is provided at a concentration of about 1.75 M. In an alternate form of the invention, the solution of aluminium chloride hexahydrate is provided at a concentration of about 2.00 M. In an alternate form of the invention, the solution of aluminium chloride hexahydrate is provided at a concentration of about 2.25 M. In an alternate form of the invention, the solution of aluminium chloride hexahydrate is provided at a concentration of about 2.50 M. In an alternate form of the invention, the solution of aluminium chloride hexahydrate is provided at a concentration of about 2.75 M. In an alternate form of the invention, the solution of aluminium chloride hexahydrate is provided at a concentration of about 3.00 M. In an alternate form of the invention, the solution of aluminium chloride hexahydrate is provided at a concentration of about 3.25 M.

The aluminium chloride solution is preferably prepared by dissolving high purity aluminium chloride hexahydrate in high purity water to the desired concentration.

It will be appreciated that the coated anode material from the step of solid/liquid separation will retain some aluminium chloride solution on their surface.

It will be appreciated that the nature of the solid/liquid separation step will have a bearing on the amount of aluminium chloride solution remaining on the coated anode material. Where the solids and liquid are separated by filtration, the filtration may be conducted under gravity or pressure differential i.e. a difference in pressure may facilitate the transfer of liquid through the filter.

Suitable filters are known in the art and include belt filters, filter presses, tube filters, frame filters or centrifuge types.

Without being limited by theory, it is believed that the coated anode material contains a coating of aluminium chloride solution held to the anode material under adhesive forces and cohesive forces including surface tension forces.

Without being limited by theory, it is believed that higher residual amounts of aluminium chloride solution remaining in the solid surface results in thicker alumina coatings.

Without being limited by theory, it is believed that more concentrated aluminium chloride solutions will generate thicker alumina coatings.

Where the step of combining the anode material with a solution of aluminium chloride hexahydrate comprises mixing the anode material with the solution of aluminium chloride solution, the aluminium chloride solution is preferably provided in excess.

In one form of the invention, the weight ratio of anode material to aluminium chloride solution is 10:90. In an alternate form of the invention, the weight ratio of anode material to aluminium chloride solution is 20:80. In an alternate form of the invention, the weight ratio of anode material to aluminium chloride solution is 30:70. In an alternate form of the invention, the weight ratio of anode material to aluminium chloride solution is 40:60. In an alternate form of the invention, the weight ratio of anode material to aluminium chloride solution is 50:50.

It will be appreciated that higher ratios of anode material to aluminium chloride solution can slurry handling problems such as poor pumpability.

In one form of the invention, the step of mixing the anode material with the solution of aluminium chloride hexahydrate is conducted for at least 0.5 hr.

In one form of the invention, the step of mixing the anode material with the solution of aluminium chloride hexahydrate is conducted for up to 3 hr.

Preferably, the step of mixing the anode material with the solution of aluminium chloride hexahydrate is conducted for about 1 hr.

In one form of the invention, the method comprises the additional step of:

drying the coated anode material to remove at least some of the free water and crystallise the aluminium chloride as aluminium chloride hexahydrate,

prior to the step of:

calcining the solid particles to form a calcined material comprising solid particles with an alumina-containing coating.

Advantageously, the step of drying the coated anode material can facilitate deagglomeration of the coated anode material.

Preferably, the step of drying the coated anode material is conducted at a temperature of less than 100° C. In one form of the invention, the step of drying the coated anode material is conducted at a temperature of between 40° C. and 100° C. In one form of the invention, the step of drying the coated anode material is conducted at a temperature of between 50° C. and 100° C. In one form of the invention, the step of drying the coated anode material is conducted at a temperature of between 60° C. and 100° C. In one form of the invention, the step of drying the coated anode material is conducted at a temperature of between 70° C. and 100° C. In one form of the invention, the step of drying the coated anode material is conducted at a temperature of between 80° C. and 100° C. In one form of the invention, the step of drying the coated anode material is conducted at a temperature of between 90° C. and 100° C.

In one form of the invention, the step of drying the coated anode material is conducted at a temperature of between 40° C. and 90° C. In one form of the invention, the step of drying the coated anode material is conducted at a temperature of between 50° C. and 90° C. In one form of the invention, the step of drying the coated anode material is conducted at a temperature of between 60° C. and 90° C. In one form of the invention, the step of drying the coated anode material is conducted at a temperature of between 70° C. and 90° C. In one form of the invention, the step of drying the coated anode material is conducted at a temperature of between 80° C. and 90° C.

In one form of the invention, the step of drying the coated anode material is conducted at a temperature of between 40° C. and 80° C. In one form of the invention, the step of drying the coated anode material is conducted at a temperature of between 50° C. and 80° C. In one form of the invention, the step of drying the coated anode material is conducted at a temperature of between 60° C. and 80° C. In one form of the invention, the step of drying the coated anode material is conducted at a temperature of between 70° C. and 80° C.

In one form of the invention, the step of drying the coated anode material is conducted at a temperature of between 40° C. and 70° C. In one form of the invention, the step of drying the coated anode material is conducted at a temperature of between 50° C. and 70° C. In one form of the invention, the step of drying the coated anode material is conducted at a temperature of between 60° C. and 70° C.

In one form of the invention, the step of drying the coated anode material is conducted at a temperature of between 40° C. and 60° C. In one form of the invention, the step of drying the coated anode material is conducted at a temperature of between 50° C. and 60° C.

In one form of the invention, the step of drying the coated anode material es is conducted at a temperature of between 40° C. and 50° C.

In one form of the invention, the step of drying the coated anode material is conducted for 10 min to 12 hr. In one form of the invention, the step of drying the coated anode material is conducted for 30 min to 12 hr. In one form of the invention, the step of drying the coated anode material is conducted for 1 hr to 12 hr. In one form of the invention, the step of drying the coated anode material is conducted for 2 hr to 12 hr. In one form of the invention, the step of drying the coated anode material is conducted for 4 hr to 12 hr. In one form of the invention, the step of drying the coated anode material is conducted for 8 hr to 12 hr.

In one form of the invention, the step of drying the coated anode material is conducted for 10 min to 8 hr. In one form of the invention, the step of drying the coated anode material is conducted for 30 min to 8 hr. In one form of the invention, the step of drying the coated anode material is conducted for 1 hr to 8 hr. In one form of the invention, the step of drying the coated anode material is conducted for 2 hr to 8 hr. In one form of the invention, the step of drying the coated anode material is conducted for 4 hr to 8 hr. In one form of the invention, the step of drying the coated anode material is conducted for 6 hr to 8 hr.

In one form of the invention, the step of drying the coated anode material is conducted for 10 min to 6 hr. In one form of the invention, the step of drying the coated anode material is conducted for 30 min to 6 hr. In one form of the invention, the step of drying the coated anode material is conducted for 1 hr to 6 hr. In one form of the invention, the step of drying the coated anode material is conducted for 2 hr to 6 hr. In one form of the invention, the step of drying the coated anode material is conducted for 4 hr to 6 hr.

In one form of the invention, the step of drying the coated anode material is conducted for 10 min to 3 hr. In one form of the invention, the step of drying the coated anode material is conducted for 30 min to 3 hr. In one form of the invention, the step of drying the coated anode material is conducted for 1 hr to 3 hr. In one form of the invention, the step of drying the coated anode material is conducted for 2 hr to 3 hr.

In one form of the invention, the step of drying the coated anode material is conducted for 10 min to 2 hr. In one form of the invention, the step of drying the coated anode material is conducted for 30 min to 2 hr. In one form of the invention, the step of drying the coated anode material is conducted for 1 hr to 2 hr.

In one form of the invention, the step of drying the coated anode material is conducted at 70° C. for 3 hr.

The step of calcining the coated anode material advantageously removes some water of crystallisation and hydrogen chloride gas. Preferably, the step of calcining the coated anode material is conducted at a temperature of 360° C. to 1000° C. In one form of the invention, the step of calcining the coated anode material is conducted at a temperature of 400° C. to 800° C. In one form of the invention, the step of calcining the coated anode material is conducted at a temperature of 400° C. to 600° C. In one form of the invention, the step of calcining the coated anode material is conducted at a temperature of about 400° C. In one form of the invention, the step of calcining the coated anode material is conducted at a temperature of about 600° C. In one form of the invention, the step of calcining the coated anode material is conducted at a temperature of about 800° C.

In one form of the invention, the step of calcining the coated anode material is conducted for 10 min to 12 hr. In one form of the invention, the step of calcining the coated anode material is conducted for 30 min to 12 hr. In one form of the invention, the step of calcining the coated anode material is conducted for 1 hr to 12 hr. In one form of the invention, the step of calcining the coated anode material is conducted for 2 hr to 12 hr. In one form of the invention, the step of calcining the coated anode material is conducted for 4 hr to 12 hr. In one form of the invention, the step of calcining the coated anode material is conducted for 8 hr to 12 hr.

In one form of the invention, the step of calcining the coated anode material is conducted for 10 min to 6 hr. In one form of the invention, the step of calcining the coated anode material is conducted for 30 min to 6 hr. In one form of the invention, the step of calcining the coated anode material is conducted for 1 hr to 6 hr. In one form of the invention, the step of calcining the coated anode material is conducted for 2 hr to 6 hr. In one form of the invention, the step of calcining the coated anode material is conducted for 4 hr to 6 hr.

In one form of the invention, the step of calcining the coated anode material is conducted for 10 min to 3 hr. In one form of the invention, the step of calcining the coated anode material is conducted for 30 min to 3 hr. In one form of the invention, the step of calcining the coated anode material is conducted for 1 hr to 3 hr. In one form of the invention, the step of calcining the coated anode material is conducted for 2 hr to 3 hr.

In one form of the invention, the step of calcining the coated anode material is conducted for 10 min to 2 hr. In one form of the invention, the step of calcining the coated anode material is conducted for 30 min to 2 hr. In one form of the invention, the step of calcining the coated anode material is conducted for 1 hr to 2 hr.

In one form of the invention, the step of calcining the coated anode material is conducted at 400° C. for 3 hr. In one form of the invention, the step of calcining the coated anode material is conducted at 600° C. for 3 hr. In one form of the invention, the step of calcining the coated anode material is conducted at 800° C. for 3 hr.

The calciner may be provided in the form of a rotary kiln, a bubbling fluidised bed, a circulation fluidised bed, a flash calciner, a suspension calciner, a tunnel kiln, a moving bed calciner or combinations thereof.

The method may comprise the additional step of adding an inert gas to the calciner.

The method may comprise the additional step of cooling the calcined material.

The method of the present invention may comprise the additional step of adding a lithium solution to the aluminium chloride solution prior to the step of combining the anode material with the solution of aluminium chloride hexahydrate solution.

The method of the present invention may comprise the additional step of adding a lithium solution prior to the step of solid/liquid separation of the slurry. The lithium solution may be added at any time prior to the step of solid/liquid separation. In one form of the invention, the lithium solution is added to the slurry of anode material and solution of aluminium chloride hexahydrate. In an alternate form of the invention, the lithium solution is added concurrently with the anode material and solution of aluminium chloride hexahydrate. In an alternate form of the invention, the lithium solution is mixed with the anode material prior to the step of mixing an anode material with a solution of aluminium chloride hexahydrate to form a slurry. In an alternate form of the invention, the lithium solution is mixed with the solution of aluminium chloride prior to the step of mixing an anode material with a solution of aluminium chloride hexahydrate to form a slurry.

The lithium solution may be prepared from a lithium salt selected from the group comprising lithium hydroxide, lithium carbonate, lithium chloride or combinations thereof. Preferred forms are lithium hydroxide monohydrate and lithium chloride and mixtures thereof.

Where the invention comprises the step of adding a lithium solution to the aluminium chloride solution, the pH of the slurry is preferably less than 3. More preferably, the pH of the slurry is less than 2.

Where the invention comprises the step of adding a lithium solution prior to the step of solid/liquid separation of the slurry, the alumina-containing coating on the calcined material may be a lithiated-alumina coating. Without being limited by theory, it is believed that such a lithiated-alumina coating may be represented by the compounds Al, O, Cl and Li, or any combination of them.

The lithium solution may be provided at a concentration of 0.01 M to 19.8 M for lithium chloride, and 0.01 M to 5.3 M for lithium hydroxide.

The addition of lithium is based on the aluminium chloride concentration of the solution. The lithium to aluminium molar ratio ranges from 1:11 to 5:1.

The method of the present invention may comprise the additional steps of:

combining a lithium solution and the calcined material comprising solid particles with an alumina-containing coating to provide a coated calcined material;

calcining the coated calcined material to form a calcined material comprising solid particles with a lithiated alumina-containing coating.

Preferably the calcined material is a powder.

In one form of the invention, the step of combining a lithium solution and the calcined material comprising solid particles with an alumina-containing coating to provide a coated calcined material comprises mixing the calcined material with the lithium solution.

Where the step of combining a lithium solution and the calcined material comprising solid particles with an alumina-containing coating to provide a coated calcined material comprises mixing the calcined material with the lithium solution, the method may comprise the additional step of solid/liquid separation to provide a liquid and the coated calcined material.

In an alternate form of the invention, the step of combining a lithium solution and the calcined material comprising solid particles with an alumina-containing coating to provide a coated calcined material comprises adding the lithium solution to the calcined material for example, by spraying and injecting the solution onto the calcined material.

The lithium solution may be prepared from a lithium salt selected from the group comprising lithium hydroxide, lithium carbonate, lithium chloride or combinations thereof. Preferably, the lithium salt is lithium hydroxide monohydrate.

The lithium solution may be provided at a concentration of 0.01 M to 19.8 M for lithium chloride, and 0.01 M tO 5.3 M for lithium hydroxide.

The lithium solution is preferably prepared by dissolving lithium chloride or/and lithium hydroxide monohydrate in high purity water to the desired concentration

It will be appreciated that the nature of the solid/liquid separation step will have a bearing on the amount of lithium solution remaining on the coated calcined material. Where the solids and liquid are separated by filtration, the filtration may be conducted under gravity or pressure differential i.e. a difference in pressure may facilitate the transfer of liquid through the filter.

Suitable filters are known in the art and include belt filters, filter presses, tube filters, frame filters or centrifuge types.

Without being limited by theory, it is believed that the coated calcined material contains a coating of lithium solution held to the calcined material under surface tension forces.

Where the step of combining the calcined material with a lithium solution comprises mixing the calcined material with the lithium solution, the lithium solution is preferably provided in excess.

In one form of the invention, the weight ratio of calcined material to lithium solution is 10:90. In an alternate form of the invention, the weight ratio of calcined material to lithium solution is 20:80. In an alternate form of the invention, the weight ratio of calcined material to lithium solution is 30:70. In an alternate form of the invention, the weight ratio of calcined material to lithium solution is 40:60. In an alternate form of the invention, the weight ratio of calcined material to lithium solution is 50:50.

It will be appreciated that higher ratios of calcined material to lithium solution can raise slurry handling problems such as poor pumpability.

In one form of the invention, the step of mixing the lithium solution and the calcined material comprising an alumina-containing coating is conducted for at least 0.5 hr.

In one form of the invention, the step of mixing the lithium solution and the calcined material comprising an alumina-containing coating is conducted for up to 3 hr.

Preferably, the step of mixing the lithium solution and the calcined material comprising an alumina-containing coating is conducted for about 1 hr.

In one form of the invention, the step of solid/liquid separation is performed with a filter. Suitable filters are known in the art and include belt filters, filter presses, tube filters or centrifuge types.

In one form of the invention, instead of mixing and filtration steps, the solution and alumina-coated anode can be mixed in a mixer.

In one form of the invention, the method comprises the additional step of:

drying the coated calcined material to remove at least some of the free water and crystallise the lithium as crystals on the alumina coating layers,

prior to the step of:

calcining the coated calcined material to form a calcined material comprising solid particles with a lithiated alumina-containing coating.

Preferably, the step of drying the coated calcined material is conducted at a temperature of less than 100° C. In one form of the invention, the step of drying the coated calcined material is conducted at a temperature of between 40° C. and 100° C. In one form of the invention, the step of drying the coated calcined material is conducted at a temperature of between 50° C. and 100° C. In one form of the invention, the step of drying the coated calcined material is conducted at a temperature of between 60° C. and 100° C. In one form of the invention, the step of drying the coated calcined material is conducted at a temperature of between 70° C. and 100° C. In one form of the invention, the step of drying the coated calcined material is conducted at a temperature of between 80° C. and 100° C. In one form of the invention, the step of drying the coated calcined material is conducted at a temperature of between 90° C. and 100° C.

In one form of the invention, the step of drying the coated calcined material is conducted at a temperature of between 40° C. and 90° C. In one form of the invention, the step of drying the coated calcined material is conducted at a temperature of between 50° C. and 90° C. In one form of the invention, the step of drying the coated calcined material is conducted at a temperature of between 60° C. and 90° C. In one form of the invention, the step of drying the coated calcined material is conducted at a temperature of between 70° C. and 90° C. In one form of the invention, the step of drying the coated calcined material is conducted at a temperature of between 80° C. and 90° C.

In one form of the invention, the step of drying the coated calcined material is conducted at a temperature of between 40° C. and 80° C. In one form of the invention, the step of drying the coated calcined material is conducted at a temperature of between 50° C. and 80° C. In one form of the invention, the step of drying the coated calcined material is conducted at a temperature of between 60° C. and 80° C. In one form of the invention, the step of drying the coated calcined material is conducted at a temperature of between 70° C. and 80° C.

In one form of the invention, the step of drying the coated calcined material is conducted at a temperature of between 40° C. and 70° C. In one form of the invention, the step of drying the coated calcined material is conducted at a temperature of between 50° C. and 70° C. In one form of the invention, the step of drying the coated calcined material is conducted at a temperature of between 60° C. and 70° C.

In one form of the invention, the step of drying the coated calcined material is conducted at a temperature of between 40° C. and 60° C. In one form of the invention, the step of drying the coated calcined material is conducted at a temperature of between 50° C. and 60° C.

In one form of the invention, the step of drying the coated calcined material is conducted at a temperature of between 40° C. and 50° C.

In one form of the invention, the step of drying the coated calcined material is conducted for 10 min to 12 hr. In one form of the invention, the step of drying the coated calcined material is conducted for 30 min to 12 hr. In one form of the invention, the step of drying the coated calcined material is conducted for 1 hr to 12 hr. In one form of the invention, the step of drying the coated calcined material is conducted for 2 hr to 12 hr. In one form of the invention, the step of drying the coated calcined material is conducted for 4 hr to 12 hr. In one form of the invention, the step of drying the coated calcined material is conducted for 8 hr to 12 hr.

In one form of the invention, the step of drying the coated calcined material is conducted for 10 min to 8 hr. In one form of the invention, the step of drying the coated calcined material is conducted for 30 min to 8 hr. In one form of the invention, the step of drying the coated calcined material is conducted for 1 hr to 8 hr. In one form of the invention, the step of drying the coated calcined material is conducted for 2 hr to 8 hr. In one form of the invention, the step of drying the coated calcined material is conducted for 4 hr to 8 hr. In one form of the invention, the step of drying the coated calcined material is conducted for 6 hr to 8 hr.

In one form of the invention, the step of drying the coated calcined material is conducted for 10 min to 6 hr. In one form of the invention, the step of drying the coated calcined material is conducted for 30 min to 6 hr. In one form of the invention, the step of drying the coated calcined material is conducted for 1 hr to 6 hr. In one form of the invention, the step of drying the coated calcined material is conducted for 2 hr to 6 hr. In one form of the invention, the step of drying the coated calcined material is conducted for 4 hr to 6 hr.

In one form of the invention, the step of drying the coated calcined material is conducted for 10 min to 3 hr. In one form of the invention, the step of drying the coated calcined material is conducted for 30 min to 3 hr. In one form of the invention, the step of drying the coated calcined material is conducted for 1 hr to 3 hr. In one form of the invention, the step of drying the coated calcined material is conducted for 2 hr to 3 hr.

In one form of the invention, the step of drying the coated calcined material is conducted for 10 min to 2 hr. In one form of the invention, the step of drying the coated calcined material is conducted for 30 min to 2 hr. In one form of the invention, the step of drying the coated calcined material is conducted for 1 hr to 2 hr.

In one form of the invention, the step of drying the coated calcined material is conducted at 70° C. for 3 hr.

The step of calcining the coated calcined material advantageously removes some water of crystallisation and hydrogen chloride gas. Preferably, the step of calcining the coated calcined material is conducted at a temperature of 360° C. to 1000° C. In one form of the invention, the step of calcining the coated calcined material is conducted at a temperature of 400° C. to 800° C. In one form of the invention, the step of calcining the coated calcined material is conducted at a temperature of 400° C. to 600° C. In one form of the invention, the step of calcining the coated calcined material is conducted at a temperature of about 400° C. In one form of the invention, the step of calcining the coated calcined material is conducted at a temperature of about 600° C. In one form of the invention, the step of calcining the coated calcined material is conducted at a temperature of about 800° C.

In one form of the invention, the step of calcining the coated calcined material is conducted for 10 min to 12 hr. In one form of the invention, the step of calcining the coated calcined material is conducted for 30 min to 12 hr. In one form of the invention, the step of calcining the coated calcined material is conducted for 1 hr to 12 hr. In one form of the invention, the step of calcining the coated calcined material is conducted for 2 hr to 12 hr. In one form of the invention, the step of calcining the coated calcined material is conducted for 4 hr to 12 hr. In one form of the invention, the step of calcining the coated calcined material is conducted for 8 hr to 12 hr.

In one form of the invention, the step of calcining the coated calcined material is conducted for 10 min to 6 hr. In one form of the invention, the step of calcining the coated calcined material is conducted for 30 min to 6 hr. In one form of the invention, the step of calcining the coated calcined material is conducted for 1 hr to 6 hr. In one form of the invention, the step of calcining the coated calcined material is conducted for 2 hr to 6 hr. In one form of the invention, the step of calcining the coated calcined material is conducted for 4 hr to 6 hr.

In one form of the invention, the step of calcining the coated calcined material is conducted for 10 min to 3 hr. In one form of the invention, the step of calcining the coated calcined material is conducted for 30 min to 3 hr. In one form of the invention, the step of calcining the coated calcined material is conducted for 1 hr to 3 hr. In one form of the invention, the step of calcining the coated calcined material is conducted for 2 hr to 3 hr.

In one form of the invention, the step of calcining the coated calcined material is conducted for 10 min to 2 hr. In one form of the invention, the step of calcining the coated calcined material is conducted for 30 min to 2 hr. In one form of the invention, the step of calcining the coated calcined material is conducted for 1 hr to 2 hr.

In one form of the invention, the step of calcining the coated calcined material is conducted at 400° C. for 3 hr. In one form of the invention, the step of calcining the coated calcined material is conducted at 600° C. for 3 hr. In one form of the invention, the step of calcining the coated calcined material is conducted at 800° C. for 3 hr.

The calciner may be provided in the form of a rotary kiln, a bubbling fluidised bed, a circulation fluidised bed, a flash calciner, a suspension calciner, a tunnel kiln, a moving bed calciner or combinations thereof.

The method may comprise the additional step of adding an inert gas to the calciner.

The method may comprise the additional step of cooling the calcined material.

### BRIEF DESCRIPTION OF THE DRAWINGS

Further features of the present invention are more fully described in the following description of a non-limiting embodiment thereof. This description is included solely for the purposes of exemplifying the present invention. It should not be understood as a restriction on the broad summary, disclosure or description of the invention as set out above. The description will be made with reference to the accompanying drawings in which:

FIG. 1 is a flow sheet of a method of preparing an anode active material in accordance with a first embodiment of the present invention;

FIG. 2 is a flow sheet of a method of preparing an anode active material in accordance with a second embodiment of the present invention;

FIG. 3 is a schematic of a laboratory furnace set up;

FIG. 4 is a present SEM photograph displaying the nano-layer alumina coating on a graphite particle;

FIG. 5 is a present SEM photograph displaying the nano-layer alumina coating on a graphite particle;

FIG. 6 is a SEM photograph displaying the nano-layer alumina coating on a silicon particle; and

FIG. 7 presents half cell test results for a composite anode.

### DESCRIPTION OF EMBODIMENTS

Throughout the specification, unless the context requires otherwise, the word “solution” or variations such as “solutions”, will be understood to encompass slurries, suspensions and other mixtures containing undissolved solids.

Throughout this specification, unless the context requires otherwise, the word “comprise” or variations such as “comprises” or “comprising”, will be understood to imply the inclusion of a stated integer or group of integers but not the exclusion of any other integer or group of integers.

Those skilled in the art will appreciate that the invention described herein is amenable to variations and modifications other than those specifically described. It is to be understood that the invention includes all such variations and modifications. The invention also includes all of the steps, features, compositions and compounds referred to or indicated in the specification, individually or collectively and any and all combinations or any two or more steps or features.

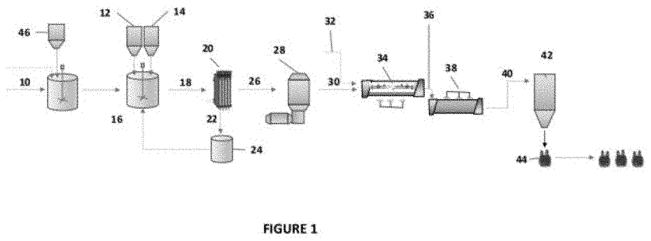

In FIG. 1 there is provided a flow sheet of a coating process in accordance with an embodiment of the present invention.

This invention presents a process to coat a nano-scale layer on the surface of anode particles by using alumina-based precursor as a major material. The thickness of coating layer is uniform and consistent. The coating layer serves as an artificial solid electrolyte interphase (SEI).

De-ionised water 10; anode powder 12 and aluminium chloride solution 14 are fed and mixed in an agitated mixing tank 16 at room temperature for a period of 0.5 hr to 3 hr, preferably about 1 hr.

The concentration of the aluminium chloride is 0.1 M to 3.44 M (saturation at 20° C.), preferably 1 M to 2 M.

The anode powder 12 may be any anode materials such as graphite, silicon carbon nanotube, Li₄Ti₅O₁₂ (spinel), TiO₂, SnO₂, Ge, Si, SOx (0<x<2), Sn, Sb, Bi and Zn. Preferred substrates are graphite powder and silicon powder. The lithium salts may be lithium hydroxide, lithium carbonate, lithium chloride or combinations thereof.

The well mixed slurry 18 is filtered in a filter 20 to remove the excess solution. The filter 20 may be a belt filter, filter press, tube filter or centrifuge types.

The filtrate 22 is collected in a tank 22 and recircled back to mixing tank 16.

The filter cake 26 is fed to dryer 28 to remove free water. The dryer 28 may be a bubbling fluidised bed type, circulation fluidised bed type, flash or impact types, vacuum dryer, suspension type including multi-cyclone type, rotary type or combinations thereof.

The dryer 28 may be provided with dust collections system, burner with combustion chamber, fans, feeders, dampers duct and other associated ancillary. The dryer 28 operates at a temperature less than 100° C., preferably 80-90° C.

The coated dried material 30 and inert gas 32 is fed to a calciner 34 to remove the water of crystallisation and HCl. During calcination, the coating changes from aluminium chloride hexahydrate to aluminum oxide. The temperature of the calcination affects the morphology of the alumina. At temperatures up to 700° C., the alumina is amorphous. Calcination over 800° C. provides crystalline alumina. The operating temperature ranges from 360° C. to 800° C., preferably 400° C. to 600° C. The calciner may be rotary kiln, bubbling fluidised bed, circulation fluidised bed, suspension, tunnel kiln or moving bed calciner or combinations thereof.

The calcined anode material 36 is discharged to a cooler 38, where the solids are cooled down to a temperature typically less than 100° C. The cooler 38 may be a rotary type, bubbling fluidised bed, circulation fluidised bed, suspension, screw cooler or moving bed type, direct or indirect. The cooling medium may be water, air or other types of gases or/and liquids.

The cooled solids 40 may be the final alumina coated anode material and directly sent to bin 42. The final product is bagged in a bagging station 44.

The de-ionised water 10 may be replaced at least in part, with a lithium salt 46 solution. The lithium content in solution is from 0 to a Li/Al mole ratio of 1. The drying and calcination procedure is the same as described above to provide an Al—O—Cl—Li compound layer on the anode particle surfaces.

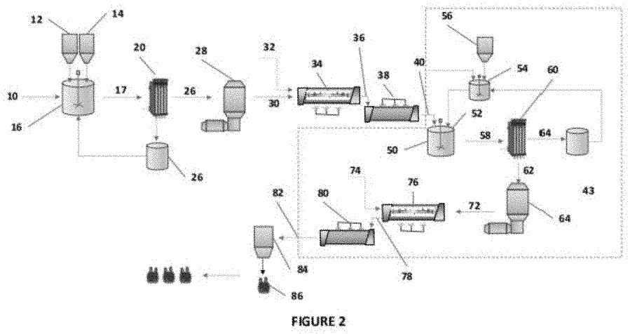

FIG. 2 describes a two-step process in accordance with a second embodiment of the invention. Cooled solids 40 from the process described above are fed to an agitated tank 50 and mixed with a lithium solution 52. The lithium solution is prepared in a preparation tank 54 by mixing deionised water and lithium salts 56. The lithium salts may be lithium hydroxide, lithium carbonate, lithium chloride or combination of them, preferable lithium hydroxide monohydrate.

The slurry 58 is pumped to a filter 60, where the solids 62 are separated from solution 64. The solution 64 is recycled to the lithium solution preparation tank 54. The filter cake 62 is fed to dryer 64 to remove free water. The filter may be a belt filter, filter press, tube filter or centrifuge types or combinations thereof. The operating temperature of the dryer ranges from 70 to 120° C., preferably 90 to 100° C. The dryer may be a bubbling fluidised bed type, circulation fluidised bed type, flash or impact types, vacuum dryer, suspension type including multi-cyclone type, rotary type or combinations thereof.

The dried material 72 coated with precursor is fed with inert gas 74 to a calciner 76. The layer turns alumina associated compound consisting of Al—O—Cl—Li. The operating temperature ranges from 600° C. to 800° C., preferably 700-800° C. The calciner 76 can be any types or combination of following types: rotary kiln, bubbling fluidised bed, circulation fluidised bed, suspension, screw type or moving bed types.

The calcined anode material 78 is discharged to a cooler 80, where the solids are cooled down to a temperature typically less than 100° C. The cooler can be a rotary type, bubbling fluidised bed, circulation fluidised bed, suspension, screw cooler or moving bed calciner.

The cooled solids 82 are stored in a product storage bin 84. The final product is bagged in a bagging station 86.

The Applicant has conducted a series of tests to demonstrate the present invention. Specifically, the Applicant has coated the graphite and silicon particles with high purity alumina layers and a lithiated-alumina layer.

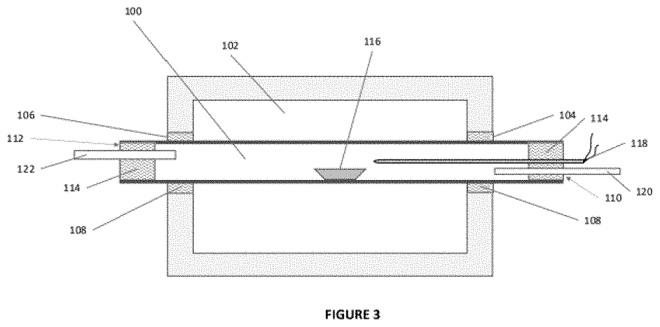

In FIG. 3 there is shown a schematic of the experimental set-up for the preparation of alumina-coated anode materials. The set-up comprises a quartz or silicon carbide tube 100 partially residing in a furnace 102. The furnace comprises a first opening 104 and a second opening 106 for retaining the tube 100. Both the first opening 104 and a second opening 106 comprise HCl resistant thermal wool 108.

The tube 100 comprises a first end 110 and a second end 112. Both the first end 110 and a second end 112 are sealed with HCl resistant thermal wool 114.

An alumina crucible 116 is provided in the centre of the tube 100, coinciding with the centre of the furnace 102.

The first end 110 of the tube 100 is provided with a thermocouple 118 extending into the tube 100 adjacent the crucible 116 and a purge gas inlet 120 if required.

The second end 112 of the tube 100 contains a vent 122 for releasing HCl gas and water vapour during calcination.

### Example 1

Graphite powder was added to an agitated container containing high purity 1M AlCl₃ solution. The graphite to AlCl₃ solution mass ratio was 20:80, providing a slurry with a solid concentration of 20%. The slurry was agitated at room temperature for 3 hr.

The slurry was filtered to remove excess solution and the filtrate recycled back for re-use. The filter cake was dried at 70° C. for 3 hr to remove free moisture. The dried material was deagglomerated and placed in a high purity alumina crucible. The crucible was fed into a tube furnace and calcined at 400° C. for 3 hr in an inert gas atmosphere (nitrogen or argon). Gas released during the calcination contained HCl and water vapor, which was directed to a gas scrubber for recovery. The calcined material was cooled down to room temperature. The calcined anode particles were coated with amorphous high purity alumina.

All the material preparations were conducted in an inert gas protected glove box.

### Example 2

High purity alumina-coated graphite prepared in accordance with Example 1 was added to an agitated solution of 1.5 M lithium hydroxide. The graphite to lithium hydroxide solution mass ratio was 20:80, providing a slurry with a solid concentration of 20%. The slurry was agitated at room temperature for 3 hr.

The slurry was filtered to remove excess solution and the filtrate recycled back for re-use. The filter cake was dried at 70° C. for 3 hr to remove free moisture. The dried material was deagglomerated and placed in a high purity alumina crucible. The crucible was fed into a tube furnace calcined at 600° C. for 3 hr in an inert gas atmosphere (nitrogen or argon). Gas released during the calcination contained HCl and water vapor, which was directed to a gas scrubber for recovery. The calcined material was cooled down to room temperature. The calcined anode particles were coated with lithiated alumina and small amount of compound of Al—Li—Cl—O.

Tables 1 to 5 below present experimental results for a variety of conditions. In the context of the present specification, ‘Dip’ refers to the addition of solid anode substrate to a coating solution such as aluminium chloride hexahydrate followed by filtration. ‘Mixing’ refers to the application of small amounts of solution by spraying onto the surface of the substrate.

Calculation of the % coating was performed by measuring the increase in mass of the calcined anode material before and after.

TABLE 1
Selected test conditions for alumina coatings on silicon.

| Si | | | Coating | Drying | Calcination | | | Alumina |
|---|---|---|---|---|---|---|---|---|
| Particle | AlCl₃ | Coating | Temp. | Temp. | Temp. | Calcination | | Coating (% |
| Size (nm) | Conc. (M) | Method | (° C.) | (° C.) | (° C.) | Time (hr) | Atm. | Al₂O₃ w/w) |
| 1000 | 0.5 | Dip | 25 | 70 | 600 | 3 | Ar | 0.76 |
| 500 | 0.5 | Dip | 25 | 70 | 600 | 3 | Ar | 0.96 |
| 500 | 0.5 | Dip | 25 | 70 | 600 | 4 | Ar | 0.28 |
| 500 | 0.25 | Dip | 25 | 70 | 600 | 3 | Ar | 0.14 |
| 500 | 0.1 | Dip | 25 | 70 | 600 | 3 | Ar | 0.12 |
| 150 | 0.5 | Dip | 25 | 70 | 400 | 3 | Ar | 0.71 |
| 150 | 0.5 | Dip | 25 | 70 | 400 | 3 | Ar | 0.49 |
| 150 | 0.5 | Dip | 25 | 70 | 600 | 3 | Ar | 0.47 |
| 150 | 1.0 | Dip | 25 | 70 | 600 | 3 | Ar | 1.47 |
| 500 | 0.5 | Mix | 25 | 70 | 600 | 4 | Ar | 0.60 |
| 500 | 0.5 | Mix | 25 | 70 | 600 | 4 | Ar | 0.51 |
| 500 | 0.5 | Mix | 25 | 70 | 600 | 4 | Ar | 0.40 |
| 500 | 0.5 | Mix | 25 | 70 | 600 | 4 | Ar | 0.31 |

TABLE 2
Selected one-step lithiated-alumina coatings on silicon.

| Si | Conc. | | Coating | Drying | Calcination | | | Alumina |
|---|---|---|---|---|---|---|---|---|
| Particle | AlCl3/Li | Coating | Temp. | Temp. | Temp. | Calcination | | Coating (% |
| Size (nm) | salt (M) | Method | (° C.) | (° C.) | (° C.) | Time (hr) | Atm. | LiAlO₂ w/w) |
| 500 | 0.5/0.5 | Dip | 25 | 70 | 600 | 3 | Ar | 0.27 |
| 500 | 0.5/0.5 | Dip | 25 | 70 | 400 | 3 | Ar | 0.72 |

TABLE 3
Selected two-step lithiated-alumina coatings on silicon.

| Si | Conc. | | Coating | Drying | Calcination | | | Alumina |
|---|---|---|---|---|---|---|---|---|
| Particle | AlCl3/Li | Coating | Temp. | Temp. | Temp. | Calcination | | Coating (% |
| Size (nm) | salt (M) | Method | (° C.) | (° C.) | (° C.) | Time (hr) | Atm. | LiAlO₂ w/w) |
| 300-500 | 0/0.5 | Dip | 25 | 70 | 400 | 3 | Ar | 1.92 |
| 300-500 | 0./0.25 | Dip | 25 | 70 | 400 | 3 | Ar | |

TABLE 4
Selected test conditions for alumina coatings on graphite.

| | | Coating | Drying | Calcination | | | Alumina |
|---|---|---|---|---|---|---|---|
| AlCl₃ | Coating | Temp. | Temp. | Temp. | Calcination | | Coating (% |
| Conc. (M) | Method | (° C.) | (° C.) | (° C.) | Time (hr) | Atm. | Al₂O₃ w/w) |
| 0.5 | Dip | 25 | 70 | 400 | 3 | Ar | 0.96 |
| 0.5 | Dip | 25 | 70 | 600 | 3 | Ar | 1.23 |
| 0.5 | Dip | 25 | 70 | 400 | 4 | Ar | 0.84 |

TABLE 5
Selected one-step lithiated-alumina coatings on graphite.

| Conc. | | Coating | Drying | Calcination | | | Alumina |
|---|---|---|---|---|---|---|---|
| AlCl₃/Li | Coating | Temp. | Temp. | Temp. | Calcination | | Coating (% |
| salt (M) | Method | (° C.) | (° C.) | (° C.) | Time (hr) | Atm. | Al₂O₃ w/w) |
| 0.5/0.5 | Dip | 25 | 70 | 800 | 3 | Ar | 0.68 |
| 0.5/0.5 | Dip | 25 | 70 | 600 | 3 | Ar | 0.49 |
| 0.5/0.5 | Dip | 25 | 70 | 600 | 3 | Ar | 1.09 |
| 0.5/0.5 | Dip | 25 | 70 | 600 | 3 | Ar | 1.19 |

TABLE 6
XRD results on coating.

| Conc. | Calcination | | | | % |
|---|---|---|---|---|---|
| AlCl3/Li | Temp. | Calcination | | % | Amor- |
| salt (M) | (° C.) | Time (hr) | Atm. | LiAl₂O_{3.5} | phous |
| 1.0/1.0 | 800 | 3 | Ar | 33 | 58 |
| 1.0/0.35 | 600 | 3 | Ar | 75 | 18 |

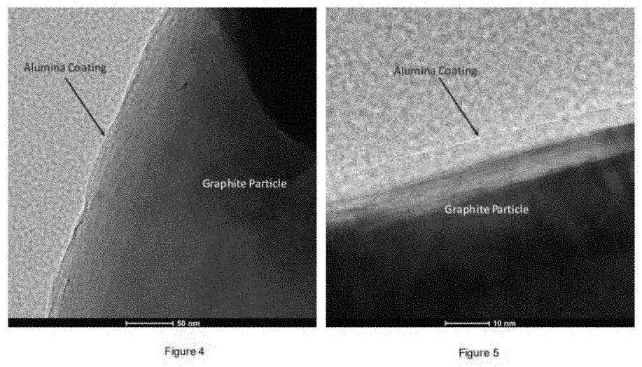

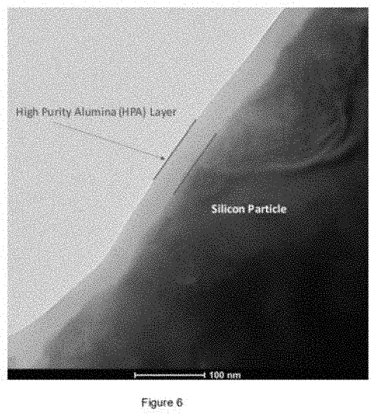

FIGS. 4 and 5 present SEM photographs displaying the nano-layer alumina coating on a graphite particle prepared under the following conditions.

| | | Coating | Drying | Calcination | | | Alumina |
|---|---|---|---|---|---|---|---|
| AlCl₃ | Coating | Temp. | Temp. | Temp. | Calcination | | Coating (% |
| Conc. (M) | Method | (° C.) | (° C.) | (° C.) | Time (hr) | Atm. | Al₂O₃ w/w) |
| 1.0 | Dip | 25 | 70 | 400 | 3 | N2 | 1.40 |

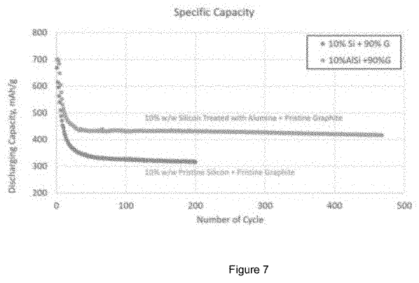

FIG. 6 presents a SEM photograph displaying the nano-layer alumina coating on a silicon particle prepared under the following conditions.

| | Conc. | | Coating | Drying | Calcination | | | Alumina |
|---|---|---|---|---|---|---|---|---|
| Si Particle | AlCl3/Li | Coating | Temp. | Temp. | Temp. | Calcination | | Coating (% |
| Size (nm) | salt (M) | Method | (° C.) | (° C.) | (° C.) | Time (hr) | Atm. | Al₂O₃ w/w) |
| 3000 | 1.00/0 | Dip | 25 | 80 | 400 | 3 | N₂ | 1.88 |

FIG. 9 presents half cell test results for a composite anode prepared under the following conditions.

| | Conc. | | Coating | Drying | Calcination | | | Alumina |
|---|---|---|---|---|---|---|---|---|
| Si Particle | AlCl3 | Coating | Temp. | Temp. | Temp. | Calcination | | Coating (% |
| Size (nm) | (M) | Method | (° C.) | (° C.) | (° C.) | Time (hr) | Atm. | AlO₂ w/w) |
| 1000 | 0.5 | Dip | 25 | 80 | 600 | 3 | N₂ | 0.76 |

Two anode material were tested in coin cell batteries for performance:

i. 10% untreated silicon+90% graphite

ii. 10% alumina coated silicon+90% graphite

The coin cells were run on a battery tester at a fixed charging/discharging rate of 0.27 C and report for specific capacity (mAh/g) in Graphic. Material 2 (grey line) reports as 430 mAh/g till 200 cycles while material 1 (orange line) reports as 330 mAh/g. It shows the alumina coating technology on silicon significantly increases the capacity of anode material in battery.

What is claimed is:

1. A method for preparing an anode active material, the method comprising the steps of:
combining an anode material with a solution of aluminium chloride hexahydrate to form a coated anode material; and
calcining the solid particles to form a calcined material comprising solid particles with an alumina-containing coating.

2. The method in accordance with claim 1, wherein the step of combining an anode material with a solution of aluminium chloride hexahydrate to form a coated anode material comprises mixing the anode material with the solution of aluminium chloride hexahydrate.

3. The method in accordance with claim 2, further comprising the step of:
solid/liquid separation to provide a liquid and the coated anode material.

4. The method in accordance with claim 1, wherein the step of combining an anode material with a solution of aluminium chloride hexahydrate to form a coated anode material comprises adding the solution of aluminium chloride hexahydrate to the anode material such as by spraying or injecting.

5. The method in accordance with claim 1, wherein the anode material is provided in the form of graphite powder, silicon powder, nano-silicon particles, silicon-carbon composite powder, carbon nanotubes Li₄Ti₅O₁₂ (spinel), TiO₂, SnO₂, Ge, Si, SOx (0<x<2), Sn, Sb, Bi and Zn.

6. The method in accordance with claim 1, wherein the solution of aluminium chloride hexahydrate is provided at a concentration of 0.1 M to 3.44 M.

7. The method in accordance with claim 1, wherein the step of combining the anode material with the solution of aluminium chloride hexahydrate is conducted for up to 3 hr.

8. The method in accordance with claim 3, wherein the step of solid/liquid separation is performed with a filter.

9. The method in accordance with claim 1, further comprising the step of drying the coated anode material to remove at least some of the free water and crystallise the aluminium chloride as aluminium chloride hexahydrate.

10. The method in accordance with claim 7, wherein the step of drying the coated anode material is conducted at a temperature of less than 100° C.

11. The method in accordance with claim 1, wherein the step of calcining the coated anode material is conducted at a temperature of 360° C. to 800° C.

12. The method in accordance with claim 1, wherein the step of calcining the coated anode material is conducted in the presence of an inert gas.

13. The method in accordance with claim 1, further comprising the step of adding a lithium solution prior to the step of combining the anode material with the solution of aluminium chloride hexahydrate.

14. The method in accordance with claim 3, further comprising the step of adding a lithium solution prior to the step of solid/liquid separation of the slurry.

15. The method in accordance with claim 13, wherein the lithium solution is added to the slurry of anode material and solution of aluminium chloride hexahydrate, or the lithium solution is added concurrently with the anode material and solution of aluminium chloride hexahydrate or the lithium solution is mixed with the anode material prior to the step of mixing an anode material with a solution of aluminium chloride hexahydrate to form a slurry or the lithium solution is mixed with the solution of aluminium chloride prior to the step of mixing an anode material with a solution of aluminium chloride hexahydrate to form a slurry.

16. The method in accordance with claim 13, wherein the lithium solution is prepared from a lithium salt selected from the group consisting of lithium hydroxide, lithium carbonate, lithium chloride and combinations thereof.

17. The method in accordance with claim 13, wherein the pH of the slurry is less than 3.

18. The method in accordance with claim 1, further comprising the steps of:
combining a lithium solution and the calcined material comprising solid particles with an alumina-containing coating to provide a coated calcined material; and
calcining the coated calcined material to form a calcined material comprising solid particles with a lithiated alumina-containing coating.

19. The method in accordance with claim 17, wherein the lithium solution is prepared from a lithium salt selected from the group consisting of lithium hydroxide, lithium carbonate, lithium chloride and combinations thereof.

20. The method in accordance with claim 17, wherein the lithium solution is provided at a concentration of 0.01 M to 19.8 M for lithium chloride, and 0.01 M to 5.3 M for lithium hydroxide.

21. The method in accordance with claim 17, wherein the slurry is about 20 W/w, solids.

22. The method in accordance with claim 17, wherein the step of mixing the lithium solution and the calcined material comprising an alumina-containing coating is conducted for up to 3 hr.

23. The method in accordance with claim 17, wherein the step of solid/liquid separation is performed with a filter.

24. The method in accordance with claim 17, further comprising the step of drying the solid particles to remove at least some of the free water.

25. The method in accordance with claim 21, wherein the step of drying the solid particles is conducted at a temperature of less than 100° C.

26. The method in accordance with claim 17, wherein the step of calcining the solid particles is conducted at a temperature of 360° C. to 800° C.

27. The method in accordance with claim 17, wherein the step of calcining the solid particles is conducted in the presence of an inert gas.
